(19) United States
(12) Patent Application Publication
(10) Pub. No.: US 2010/0070898 A1
(43) Pub. Date: Mar. 18, 2010

(54) CONTEXTUAL WINDOW-BASED INTERFACE AND METHOD THEREFOR

(76) Inventors: Daniel Langlois, Montreal (CA); Guy Labelle, Montreal (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/447,141

(22) PCT Filed: Oct. 26, 2007
(86) PCT No.: PCT/CA07/01910

§ 371 Date: Sep. 18, 2009

(30) Foreign Application Priority Data
Oct. 26, 2006 (CA) 2565756

(51) Int. Cl. G06F 3/048; G06F 15/16

(52) U.S. Cl. 715/769; 715/804; 709/219

(57) ABSTRACT

A contextual windows-based interface and a computer-implemented method for use with the contextual windows-based interface are provided. The interface consists of several generally adjacently disposed contextual windows wherein each contextual window generally leads to an application and/or data or can contain further levels of related contextual windows, each of them leading to other applications and/or data. The method associated with the interface allows for the contextual windows to interact with each other in order to provide additional functionalities. Hence, the method provides for the selection of contextual windows and for the creation of interactional data based on the combination of the data related to the selected contextual windows. The interactional data can be used to update the content of one or more contextual windows and/or can be transmitted to a remote server, via a communication network, for further processing.

### CROSS-REFERENCE TO RELATED APPLICATIONS

The present patent application claims the benefits of priority of commonly assigned Canadian Patent Application No. 2,565,756, filed at the Canadian Intellectual Property Office on Oct. 26, 2006.

### FIELD OF THE INVENTION

The present invention generally relates to computer interfaces and to methods for use with such computer interfaces. More particularly, the present invention relates to contextual window-based interfaces and to methods for use with such contextual window-based interfaces.

### BACKGROUND OF THE INVENTION

In recent years, we have seen an explosion in the number of electronic devices. Moreover, with the progress in electronics, image processing and display screen technology, more and more electronic devices are provided with electronic screens of different size and resolution.

Accordingly, electronic display screens now come in a multitude of size and resolution and their display area varies from a few square inches for cellular phones to several square feet for full size desktop computer screen and large television screens.

The main problem with these different types of screens is that the interface used for example on a desktop computer screen cannot simply be scaled down and used on the screen of a cellular phone. Thus, each time a new device is designed with a particular screen, a customized interface must generally be created and programmed for to fit the particular screen of the new device, with all the additional cost this customized interface can incur.

In order to mitigate the above-mentioned problems, new interfaces have been recently proposed. One particularly interesting interface is the tile-based interface in which applications are accessible through a grid of generally non-overlapping dynamic tiles.

Examples of interfaces based on tiles are shown in U.S. Patent Application Publication No. 2007/0082707 and more particularly in U.S. Patent Application Publication No. 2006/0190833.

Though useful for their intended purposes, the interfaces disclosed in these prior art documents consist mainly in a new way to display and access applications. Yet, they still lack the additional functionalities modern electronic devices generally require. Hence, there is a need for an improved interface and methods for use therewith.

### OBJECTS OF THE INVENTION

Accordingly, one of the main objects of the present invention is to provide an interface based on the use of contextual windows and a computer-implemented method for use with such an interface.

Another object of the present invention is to provide an interface based on the use of contextual windows which generally adapts itself to the capabilities, such as size and resolution, of the screen onto which it is displayed.

Another object of the present invention is to provide an interface based on the use of contextual windows in which each contextual window lead to one or more applications and/or one or more sets of data.

Still another object of the present invention is to provide an interface based on the use of contextual windows and a computer-implemented method for use with such an interface which allow the contextual windows to interact with each other.

Yet another object of the present invention is to provide an interface based on the use of contextual windows and a computer-implemented method for use with such an interface in which the selection and combination of contextual windows allows the creation of interactional data.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

The present invention generally provides an improved contextual window-based interface and a novel computer-implemented method for use with such a contextual window-based interface which generally mitigates the problems of the prior art.

As used hereinabove and hereinafter, a “contextual window” is a window which generally identifies an application and provides access thereto, which generally dynamically provides an indication of the type of data hosted by the application and which generally provides the current state of the application.

Generally speaking, a contextual window leads to at least one application and to at least one set of data related to the application or applications. The application or applications can be either passive in the sense that they only provide information (a “News” contextual window) or interactive in the sense that they allow the user to enter information and/or allow the user to interact (e.g. a “Game” contextual window).

According to an aspect of the present invention, the interface generally provides a grid, stack or cluster of generally non-overlapping contextual windows which generally adapts itself to the screen of the device onto which it is used. Hence, the number of contextual windows displayed at any given time on a particular screen will depend on the capabilities of the screen such as its size and/or its resolution. For instance, the number of contextual windows displayed on a cellular phone screen will generally be substantially less than the number of contextual windows displayed on a laptop or desktop screen. Still, according to the invention, the same interface could be used on both.

In order to compensate for the size and/or the resolution of the screen onto which the interface is used, the interface allows the user to navigate through the contextual windows and see and/or select undisplayed contextual windows simply by inputting panning commands via an inputting unit such as, but not limited to, directional buttons, a point (e.g. mouse, stylus, track ball) or a touch sensitive screen or pad. Still, the present invention is not so limited.

Once a contextual window of the interface is selected by the user, the interface will generally enlarge the selected contextual window to provide a better view of the application. Ultimately, the selected windows could be enlarged to completely occupy the screen. Understandably, the window would revert back to its normal size once the application is over or when the user wishes to access another window; the present invention is however not so limited.

According to an aspect of the present invention, when a selected window is only partially enlarged (i.e. the enlarged window does not occupy the full screen), the other windows can either be temporarily hidden and/or reduced. In an exemplary embodiment, the reduced contextual windows could be provided as a film strip at the bottom of the screen. Still, other embodiments are also possible.

According to another aspect of the invention, a contextual window can lead to another level of contextual windows related to the parent window. For example, a “Communication” window could lead to another level of contextual windows, all related to communication but providing more specific communication applications. Thus, the “Communication” window could, for example, lead to another level containing other communication related contextual windows such as an “E-mailing” window, an “Instant Messaging” window, a “Paging” window, a “Calling” window. The number of levels in the hierarchy of contextual windows is generally not limited.

According to another aspect of the present invention, the interface is preferably uploaded, via a remote central server, to the electronic device of each user wishing to use it. Alternatively, the interface could be downloaded from the remote server by each user. Still, either through uploading or downloading, the interface could be updated (e.g. new contextual windows, cancelled contextual windows, updated contextual windows, etc.). Understandably, the devices using the interface of the present invention are preferably adapted to be connected to a communication network.

According to an important aspect of the present invention, each contextual window is linked to at least one software application and to a set of data linked to the at least one software application. Understandably, the software application and the related data are stored in the memory unit or units of the device. Additionally, each contextual window is also generally self-sufficient in the sense that it generally does not need to access external application(s) or data to run its related application. For example, a “Survey” contextual window will generally contain the necessary application or applications and data such as, but not limited to, an interactive questionnaire application and questionnaire files, for providing a complete survey to the user. Hence, if the questionnaire application and/or the questionnaire files of the “Survey” contextual window are updated by the server, the other contextual windows will not be affected by the modification. Conversely, if the application and/or the data associated with another contextual window are updated, the questionnaire application and the questionnaire files will not be affected. However, an action undertaken during the use of an application in a contextual window can alter or modify the data of another contextual window.

According to an important aspect of the present invention, the interface also provides for interactions between contextual windows preferably, but not exclusively, located in the same level. Preferably, the interactions would create additional functionalities and/or data. For example, by simply dragging and dropping a first contextual window over a second contextual window, certain interactional data could be created and/or certain additional functionalities could be offered to the user. For example, a “Pictures” window could be dragged and dropped over the aforementioned “Communication” window and the interface would retrieve the data related to both windows, process them and then propose the user to send a picture or pictures via a communication media (e.g. instant messaging, email, etc.) to be selected, possibly via another window, by the user. Also, by simply dragging and dropping a “Shopping” contextual window over a “User Account” window, data related to the “Shopping” window (e.g. identification and price of a product) and to the “User Account” window (e.g. user address and credit card number) could be process to generate interactional data (e.g. transactional data) and a shopping transaction could be initiated by transmitting these transactional data to a remote server for further processing. Understandably, other combinations are also possible.

According to the invention, the contextual window-based interface and the related method could be implemented on any electronic device having a display screen and having minimal computing hardware (e.g. processing unit, memory unit, inputting unit and networking unit). Hence, without being limitative, the contextual window-based interface and the related method could be used on cellular and/or smart phones, portable gaming consoles, desktop and/or portable computers, personal digital assistants, etc.

Hence, the features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 shows an exemplary electronic device onto which the interface and method of the present invention can be implemented.

FIG. 2 is a schematic view of the different components of the electronic device of FIG. 1.

FIG. 3 shows the exemplary electronic device of FIG. 1 with an embodiment of the interface of the present invention display on the screen.

FIG. 3a is a schematic view of another exemplary embodiment of the interface system of the present invention.

FIG. 4 shows the exemplary electronic device of FIG. 1 with a first embodiment of the interface of FIG. 3 wherein a selected window is enlarged.

FIG. 4a is a schematic view of the embodiment of the interface of FIG. 3a wherein a selected window is enlarged.

FIG. 5 shows the exemplary electronic device of FIG. 1 with a second embodiment of the interface of FIG. 3 wherein a selected window is enlarged.

FIG. 6 shows the exemplary electronic device of FIG. 1 with an embodiment of the interface of the present invention display on the screen.

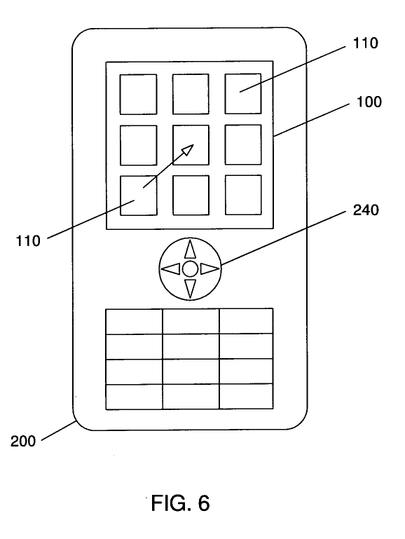

FIG. 7 is a schematic view of a flow chart of an exemplary way to create and transmit the interface of the present invention.

FIG. 7a is a schematic view of an exemplary flow chart according to the flow chart of FIG. 7.

### DETAILED DESCRIPTION OF THE PREFERRED EMBODIMENT

An interface and a computer-implemented method will be described hereinafter. Although the invention is described in terms of specific illustrative embodiments, it is to be understood that the embodiments described herein are by way of example only and that the scope of the invention is not intended to be limited thereby.

The interface of the present invention is generally configured and adapted to be used on any electronic device having an adequate display screen and minimal hardware. Hence, the interface can generally be transported from one device to another without significant change. As a matter of fact, the interface will generally adapt itself to the screen of the device onto which it is used by taking into account parameters such as, but not limited to, size and resolution. Accordingly, in a non-exhaustive list, the interface and method of the present invention could be implemented on cellular and/or smart phones, portable gaming consoles, desktop and/or portable computers, personal digital assistants, etc. The present invention is not so limited.

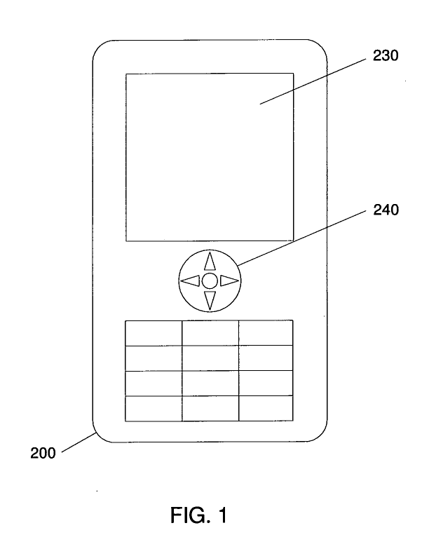

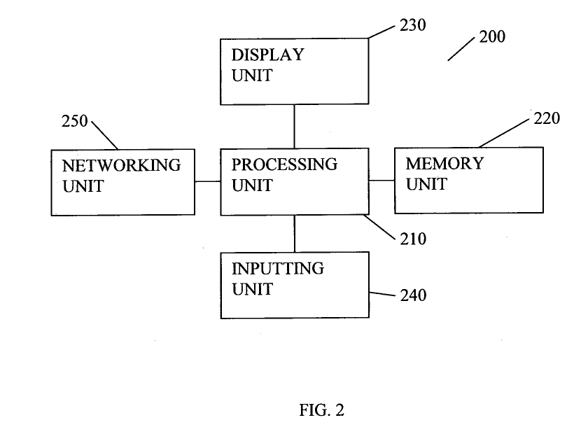

Referring to FIG. 1, an exemplary electronic device 200, adapted to support the interface, is shown. The device 200, which is a cellular phone in the present exemplary case, generally comprises at least a display unit 230 (e.g. display screen) for displaying the interface and an inputting unit 240 (e.g. directional buttons) for allowing the user to input commands. Referring now to FIG. 2, the device 200 also generally comprises a processing unit 210 (e.g. central processing unit) for processing the instruction set of the interface and for processing different data. The processing unit 210 is in electronic communication with the aforementioned display unit 230 and inputting unit 240 and also with a memory unit 220 and to a networking unit 250. Understandably, the memory unit 220 provides storage for the instruction set of the interface and for the different data sets required to support the interface whereas the networking unit 250 provides the necessary signal processing for allowing the device 200 to access a communication network (not shown).

Understandably, the device 200 could comprise additional units such as, but not limited to, a global positioning unit (e.g. GPS unit) for providing location data. The number and type of units will generally depend on the complexity and/or intended use of the device.

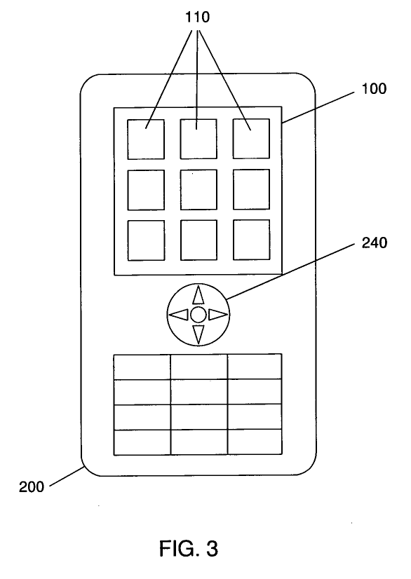

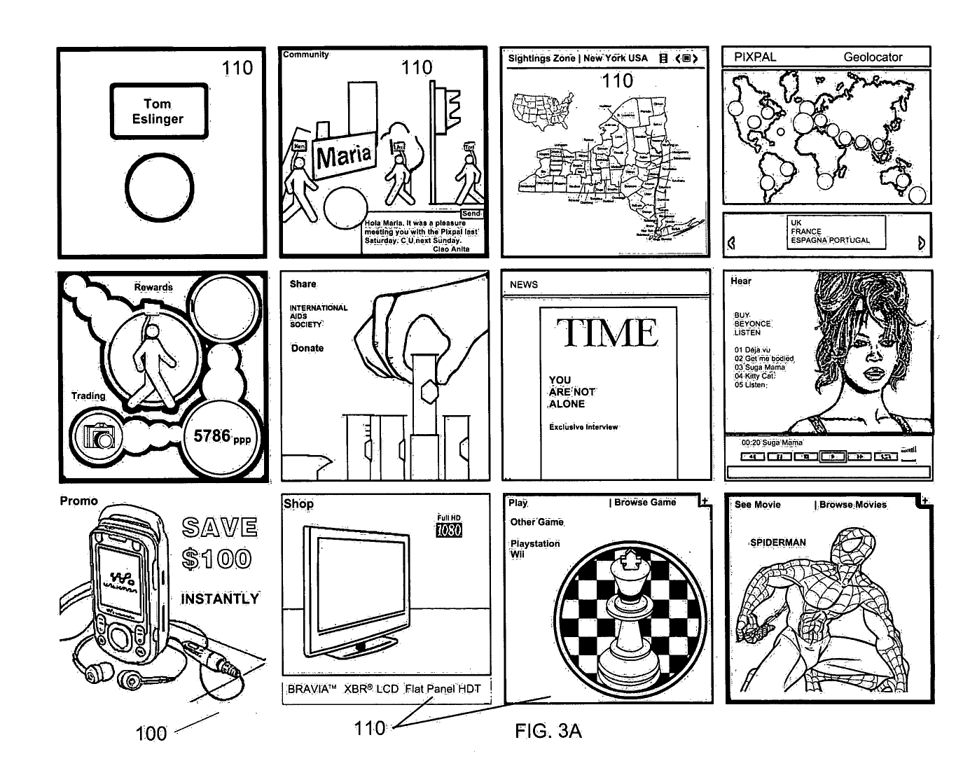

Referring now to FIGS. 3 and 3a, an example of an embodiment of the interface 100 of the present invention is shown. The interface 100 generally comprises a grid, stack or cluster of generally non-overlapping contextual windows 110 which are generally adjacently disposed and aligned in multiple rows and columns in order to mostly fill the entire screen 230.

As mentioned above, a contextual window 110 is a window which generally identifies an application and provides access thereto, which generally dynamically provides an indication of the type of data hosted by the application and which generally provides the current state of the application.

Since the interface 100 can be used on any types of screens, the interface 100 will preferably adjust the number of windows actually displayed in order to take into account the size and the resolution of the screen. Thus, at a given time, certain windows 110 can be either temporarily hidden or reduced in order for the other contextual windows 110 to be readable. Yet, these hidden or reduced windows remain accessible by inputting panning commands via the inputting unit 240. Understandably, though directional buttons 240 are shown as inputting unit 240, other means to input commands such as a touch screen or a pointer (e.g. mouse or stylus) can also be used. The present invention is not so limited.

In a preferred embodiment of the interface 100, each contextual window 110 generally defines a different context and leads to different applications. For example, as shown in FIG. 3a, there can be windows relating to “News”, “Hear” (i.e. music), “Play” (i.e. game), “See” (i.e. images and video), “Community”, “Shop”, etc. The interface 100 of the present invention is not limited to any specific contextual windows. As a matter of fact, though the interface 100 and the contextual windows 110 are preferably provided by third parties as part of a software package which can be regularly and/or automatically updated, it remains a possibility that the interface 100 and/or one or more contextual windows 110 could be configured or designed by the user. For example, the interface 100 could be configured to show only certain specific windows 100 chosen by the user.

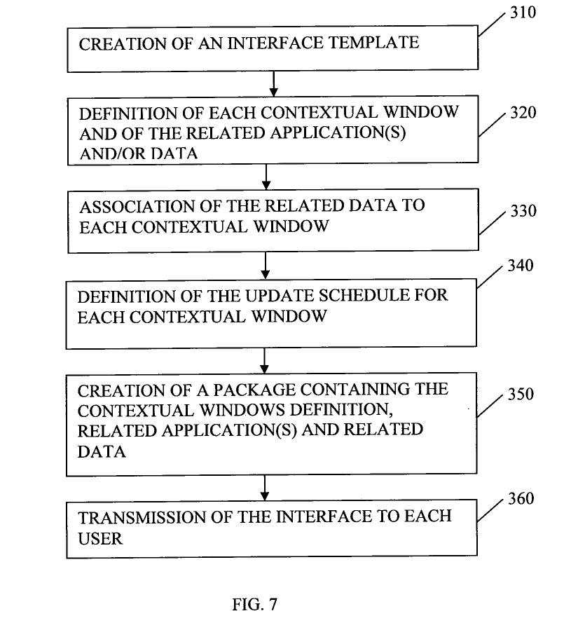

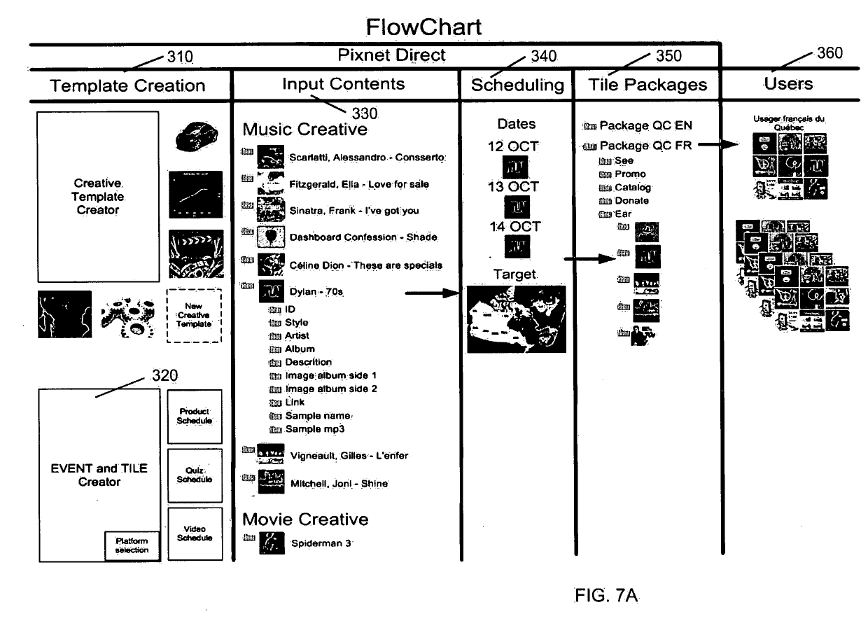

In any case, in accordance with the preferred embodiment and a shown in the exemplary flow charts of FIGS. 7 and 7a, the content (e.g. the application(s) and the data related thereto) of each contextual window 110 is preferably created by one or more third parties, using appropriate softwares (step 310), which will further define the content (e.g. application(s) and/or data) of each contextual window 110 (step 320), associates the application(s) and/or the data to each contextual window 110 (step 330), schedule the sequence of updates for each contextual window 110 (step 340), package the interface 100, the contextual windows 110 and the related application(s) and data (step 350) and transmit the package to each device 200 via the communication network (step 360).

In the present interface 100, each window 110 is preferably self-sufficient. In other word, each window 110 contains its own software application or applications and its own set of data, both of which are stored on the memory unit 220 of the electronic device 200. Hence, if a window 110 is selected, all the necessary data and/or applications will be available in that particular window. For example, if the “Hear” window is selected, than the necessary data (e.g. music files, playlists, etc.) and applications (e.g. music sharing application, media player application, music file management application, etc.) will be available and accessible in the “Hear” window.

The fact that each contextual window 110 is preferably self-sufficient provides the additional advantage that the application(s) and/or the data associated with each contextual window 110 can be updated independently by third parties via the communication network. Hence, an update of the “Hear” window (e.g. new songs, updated player) will generally not have any impact on the other contextual windows 110.

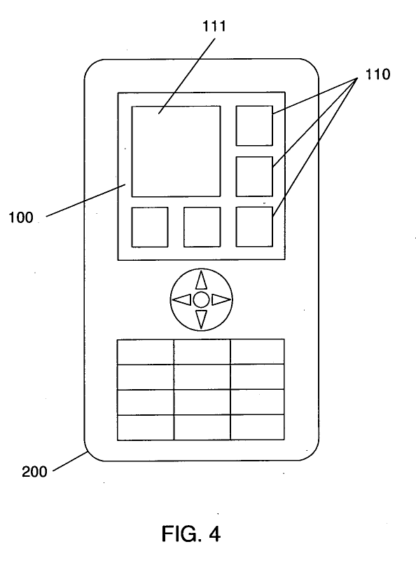

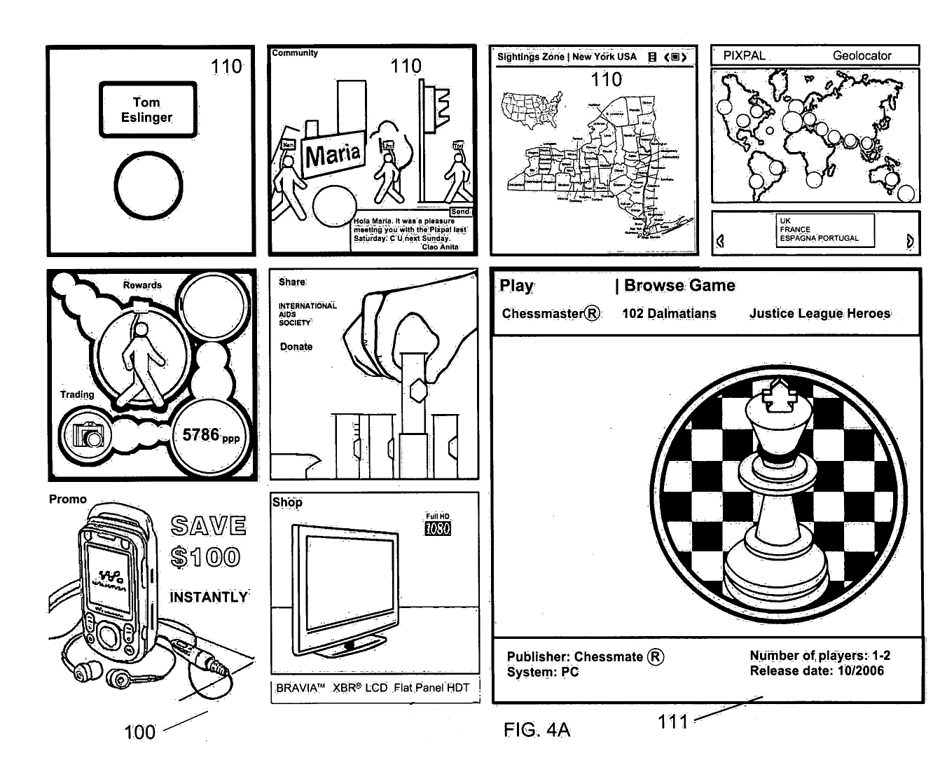

As shown in FIGS. 4 and 4a, when a window 111 is selected, it is preferably enlarged so that the user can more efficiently see and interact with its content. In the example of FIG. 4a, the contextual “Play” window 111 has been selected and is therefore correspondingly enlarged. Depending on the type of applications or the context of the window, once it is selected, it can be enlarged to take a larger portion of the screen or ultimately, to be displayed full screen.

Once a particular window 111 is selected and enlarged, a portion of the other windows 110 can either be temporarily hidden, as in FIG. 4 or they can be reduced in size a shown in the upper left corner of FIG. 4a. Understandably, the interface will generally adapt itself to the display unit 230 onto which it is used. Therefore, if the interface 100 is used on the screen of a cellular phone, as in FIG. 1, the other windows 110 are more likely to be temporarily hidden since their reduction would likely render them unreadable. However, if the interface 100 is used on a laptop, the other windows 110 are more likely to be temporarily reduced since they would remain readable due to the larger size and better resolution of the screen. Still, the present invention is not so limited.

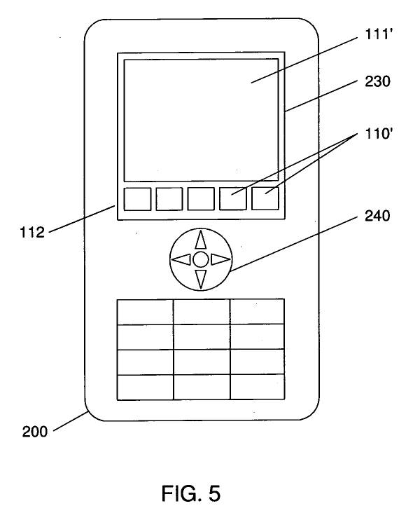

According to another embodiment of the present invention, as shown in FIG. 5, when a selected window 111′ is enlarged, the remaining windows 110′ can be reduced and presented as a film strip 112′ underneath the enlarged selected window 111′. This latter embodiment may be preferred on devices 200 having smaller screen 230 such as cellular phones since it allows the user to easily access the reduced contextual windows 110′ by scrolling the film strip 112′ via the inputting unit 240.

In any case, the interface 100 of the present invention is not limited to the embodiment described hereinabove.

Moreover, a contextual window 110 can lead to another level containing other context-related windows 110. The windows 110 displayed in the child level are preferably related contextual windows leading to more specific applications and/or more specific data. For example, the main window 110 labelled “Hear” could lead, once selected by the user, to a child level containing other windows 110. In the child level, the contextual windows 110 could lead to specific applications related to music. For example, the child level could comprise contextual windows 110 leading to a music sharing application, a music downloading application, a music file management application and/or a music playing application. Understandably, the numbers of windows 110 in the child level could vary for each contextual window 110. For example, the main window 110 labelled “News” could lead, if selected, to a child level of contextual windows 110 containing more windows 110 than the child level of the “Hear” window 110. These windows 110 could be labelled “Local”, “National”, “International”, “Gossip”, “Technological”, and “Financial”. Understandably, the present invention is not so limited.

Understandably, the numbers of windows 110 could vary for each context. Still, a main contextual window 110 could directly lead to an application without displaying a child level of additional windows 110.

According to an important aspect of the present invention, even though each contextual window is essentially self-sufficient, the action taken in one window can affect the content of one or more other windows. For example, selecting a particular song to be played in the “Hear” window can prompt the “Shopping” window to propose one of the albums of the artist for purchase. Additionally, the “Promo” window could also be updated to offer savings on certain of the albums. To do so, the processing unit 210 of the device 200 can send data relating to the song currently playing to the remote server, via the networking unit 250, and the remote server can transmit back updated data relating to the “Shopping” and/or “Promo” windows in order for these window to display products associated with the currently playing song.

In addition, the interface 100 is further provided with the possibility to combine contextual windows 110 in order to create additional functionalities and/or additional data. Hence, according to the invention, by simultaneously selecting at least two contextual windows 110, the processing unit 210 of the device will retrieve the data related to each window 110 from the memory unit 220 and will process them in order to create interactional data. In addition to the creation of interactional data, the processing unit 210 can further generate additional functionalities. Preferably, the at least two selected contextual windows 110 can be combined by dragging and dropping a first contextual window 110 over a second contextual window 110.

In accordance with one aspect, the interactional data created during the interaction between two contextual windows 110 could be used to update or modify the data related to one or more contextual windows 110. For example, referring to FIG. 3a, by dragging and dropping the contextual windows “Rewards” over the contextual window “Share”, the processing unit 210 will retrieve the data related to the “Rewards” window (e.g. the number of reward points) and the data related to the “Share” window (e.g. the non-lucrative organisation information) and will offer the user to enter the number of points to transfer to the non-lucrative organisation. Upon entering a number, interactional data will be created and stored on the memory unit 220 of the device. In addition, the interactional data will include the updated remaining number of reward points and will be used to update the “Rewards” window accordingly.

Alternatively, the interactional data can be transmitted to a remote server (not shown) via a communication network which can be accessed by the networking unit 250 of the device 200. Understandably, different communication protocols could be used for the transmission of interactional data; the present invention is not so limited.

For example, referring to FIG. 3a, the interface 100 could comprise a contextual window labelled “Promo” and another one labelled “Shopping”. The interface would therefore provide the user with the possibility to drag the window “Promo” onto the window “Shopping”. By doing so, the processing unit 210 of the device would retrieve, from the memory unit 220, the data related to the promotion (e.g. the value of the rebate) displayed in the “Promo” window 110 and the data related to the article (e.g. article description and price) displayed in the “Shopping”, would process these data (e.g. apply the rebate to the promoted article), would generate interactional data based on data related to the promotion and the data related to the article and would possibly offer the user ways to complete a transaction by transmitting the interactional data (e.g. transactional data) to the remote server for further processing.

In addition to transmitting the interactional data to the remote server, the interactional data could also be stored in the memory unit 220 of the device 200 and be used, for instance, the update the “Rewards” window with the updated amount of reward points if the transaction generates reward points. Understandably, the possibilities of combinations of windows are endless and only limited by the applications and data associated with each contextual window.

According to another aspect of the invention, the appearance of the different contextual windows is also dynamic in nature. Hence, the appearance or content of a particular window can change according to the status of the application(s) associated therewith and/or according to change(s) in the data associated therewith. For example, if a new e-mail has arrived in a user mailbox, the appearance of the “Communication” window 110 can change and display “New mail”. As another example, the appearance of the “Promo” window 110 can change as different promotions are offered to the user. The present invention is however not so limited.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A method executed on an electronic device comprising a display unit, a processing unit under the control of a program and a memory unit, said method comprising:
a. partitioning said display unit into an array of contextual windows, each of said contextual windows having related data stored on said memory unit;
b. selecting a first of said contextual windows and a second of said contextual windows;
c. retrieving, from said memory unit, first data related to said first contextual window and second data related to said second contextual window;
d. processing, with said processing unit, said first data and said second data to generate interactional data;
e. storing said interactional data on said database.

2. A method as claimed in claim 1, further comprising the step of updating data related to at least one of said contextual windows using at least a portion of said interactional data.

3. A method as claimed in claim 2, further comprising the step of updating said at least one of said contextual windows using said updated data.

4. A method as claimed in claim 1, wherein said interactional data comprise transactional data.

5. A method as claimed in claim 4, further comprising the step of transmitting said transactional data to a remote server system via a communication network.

6. A method as claimed in claim 1, wherein said selection is made by dragging and dropping said first contextual window over said second contextual window.

7. An electronic device comprising:
a. a processing unit;
b. a memory unit in electronic communication with said processing unit;
c. a display unit in electronic communication with said processing unit and adapted to be partitioned into an array of contextual windows, each of said contextual windows having related data stored on said memory unit;
d. an inputting unit in electronic communication with said processing unit and adapted to receive command inputs for at least the selection of a first said contextual window and a second said contextual window;
e. a networking unit electronic communication with said processing unit and adapted to access a communication network;
wherein said processing unit is adapted to retrieve, from said memory unit, first data related to said first contextual window and second data related to said second contextual window in order to process said first data and said second data to generate interactional data.

8. A method as claimed in claim 7, wherein said interactional data comprise transactional data.

9. A method as claimed in claim 8, wherein said networking unit is further adapted to transmit said transactional data to a remote server system via said communication network.

10. A method as claimed in claim 7, wherein said input commands comprise commands to drag and drop said first contextual window over said second contextual window.

11. An electronic device as claimed in claim 7, wherein said inputting unit is a set of directional buttons.

12. An electronic device as claimed in claim 7, wherein said inputting unit is touch screen.

13. An electronic device as claimed in claim 7, wherein said inputting unit is a pointer.
